(19) United States
(12) Patent Application Publication
(10) Pub. No.: US 2004/0203414 A1
(43) Pub. Date: Oct. 14, 2004

(54) Wearable electronic device

(76) Inventors: Katsuhiko Satou, Chiba-shi (JP); Yoshinori Bito, Chiba-shi (JP)

Correspondence Address: ADAMS & WILKS, 31st Floor, 50 Broadway, New York, NY, 10004, US

(21) Appl. No.: 10/378,725

(22) Filed: Mar. 4, 2003

(30) Foreign Application Priority Data
Mar. 5, 2002 (JP) 2002-058587
Feb. 21, 2003 (JP) 2003-043803

(51) Int. Cl. H04B 7/00

(52) U.S. Cl. 455/66.1; 368/13

(57) ABSTRACT

A wearable electronic device is offered in which sound radiation and sound reception operations of an electroacoustic converter are performed reliably. The wearable electronic device can be a personal digital assistant (PDA) having an enclosure portion that is worn on a user's wrist in use. The electroacoustic converter is incorporated in the enclosure portion. Sound radiation and reception holes extending through the wall of the enclosure portion are formed between the inner surface and the outer surface of the enclosure portion. The inner surface surrounds the converter, while the outer surface makes contact with the user's wrist when the device is worn. The enclosure portion has recessed or convex portions on or in portions of the outer surface around the openings of the sound radiation and reception holes to form acoustic signal propagation paths. These paths permit propagation of acoustic signals between the openings of the sound radiation and reception holes and the outer environment when the enclosure portion is worn on the user's wrist and the surface portions around the openings make contact with the user's wrist.

### BACKGROUND OF THE INVENTION

1. Field of the Invention

The present invention relates to a wearable electronic device such as a wrist-mounted cell phone that is mounted to a wrist and used.

2. Description of the Related Art

In recent years, with the spread of mobile electronic devices, various wearable electronic devices that are mounted to the user's body in use have been proposed. Among these wearable electronic devices, a wearable electronic device of the type in which electroacoustic converters such as speaker and microphone are provided in an enclosure has acoustic holes extending through the wall of the enclosure between the inner surface surrounding the electroacoustic converters and the outer surface that is brought into contact with the user's body when the device is mounted. An acoustic signal emanating from the speaker is radiated out through the acoustic holes. An acoustic signal such as user's voice is transmitted to a sound reception portion of the microphone via sound reception holes.

However, if the user attempts to utilize this kind of wearable electronic device equipped with electroacoustic converters in a so-called hands-free manner (i.e., the device is placed in intimate contact with the user's body without holding the device with the user's hand), the sound radiation holes in the front surface of the speaker and the sound reception holes in the front surface of the microphone are brought into intimate contact with the surface of the user's body such as an arm and easily plugged up. As a result, speaker's sound is not easily radiated out through the sound radiation holes. This leads to a decrease in the speaker's sound pressure. There is also a danger that speech greatly attenuates before reaching the sound reception holes in the microphone, giving rise to a decrease in the sensitivity of the microphone.

There are various proposals with a view to improving the acoustic characteristics of mobile electronic devices in a broad meaning.

For example, in a proposal made in JP-A-10-304036, sound-leaking holes are formed on the outer side of the region of the casing of a cell phone that is opposite to the user's ear to permit an acoustic signal having substantially constant frequency characteristics to reach the user's ear, whether or not the user of the cell phone brings the user's ear into intimate contact with the wall of the casing (enclosure) that is ahead of the speaker and provided with sound radiation holes. This region is referred to as the sound radiation hole formation region. Furthermore, in JP-A-11-308314, there is disclosed a technique for forming acoustic holes in both surfaces of a flip into which a microphone is built, the flip being capable of rotating between a closed position where the flip overlaps the body of a cell phone and an open position where the flip forms an angle to the body, in order to improve the frequency characteristics in both open and closed positions.

Either case is associated with improvement of the acoustic characteristics of electroacoustic converters in a mobile electronic device but not associated with the problems with sound radiation and reception operations which are caused by the mode of usage intrinsic to the wearable electronic device, that is, sound radiation holes in the front surface of the speaker and sound reception hole in the front surface of the microphone are brought into intimate contact with the surface of the user's body and substantially become plugged up. Consequently, any means that solves this problem is not disclosed.

### SUMMARY OF THE INVENTION

In view of the foregoing, the present invention has been made. It is an object of the invention to provide a wearable electronic device assuring sound-radiating or sound-receiving operation of electracoustic converters.

To achieve this object, a wearable electronic device according to the invention has an electroacoustic converter and an enclosure having an inner surface surrounding the electroacoustic converter and an outer surface including an intimate contact surface portion that is placed in intimate contact with the surface of the body of a user except for the ears and mouth when the device is mounted. This electronic device is characterized in that the enclosure has acoustic signal propagation path formation means that provides an acoustic signal propagation path permitting propagation of acoustic signals between an exposed surface portion of the outer surface of the enclosure and the inner surface. The exposed surface portion is moved off the surface of the user's body and faces the outside environment when the device is mounted.

The wearable electronic device of the invention is characterized in that “the enclosure has the acoustic signal propagation path formation means that provides an acoustic signal propagation path permitting propagation of acoustic signals between the exposed surface portion of the outer surface of the enclosure and the inner surface, the exposed surface portion being moved off the surface of the user's body and facing the outside environment when the device is mounted.” Therefore, even if the wearable electronic device is mounted to the user's body and the enclosure of the device is placed in intimate contact with the surface of the user's body, the acoustic signal propagation path formation means secures the acoustic signal propagation path along which acoustic signals are propagated, between the inner surface and the outside environment. Consequently, any blockage or attenuation hindering propagation of acoustic signals between the electroacoustic converter and the outside environment can be circumvented. Accordingly, where the electroacoustic converter is a converter of the type for converting an electrical signal into an acoustic signal such as a loudspeaker, if the wearable electronic device is mounted to the user's body and the enclosure of the wearable device is placed in intimate contact with the surface of the user's body, acoustic signals from the electroacoustic converter are propagated to the outside environment via the acoustic signal propagation path formed between the inner surface of the enclosure and the outside environment by the acoustic signal propagation path formation means and can reach user's ear. Where the electroacoustic device is a converter of the type for converting an acoustic signal into an electrical signal such as a microphone, even if the wearable electronic device is mounted to the user's body and the enclosure of the wearable device is placed in intimate contact with the surface of the user's body, acoustic signals such as speech uttered by the user are propagated to the electroacoustic converter such as a microphone via the acoustic signal propagation path formed between the outside environment and the inner surface of the enclosure by the acoustic signal propagation path formation means. The signals can be converted into electrical signals. Consequently, in the wearable electronic device according to the invention, sound radiation or reception operation can be reliably performed.

In the description above, the “outer surface of the enclosure” means a surface portion which is located on the outside of the enclosure accommodating the electroacoustic converter and which touches the user's body when the enclosure of the wearable device is mounted to the user's body. Accordingly, while the enclosure of the wearable device is mounted to a wrist or other portion of the user, the whole wearable electronic device assumes the form of a ring. With respect to this ring, its inner surface corresponds to the “outer surface” of the enclosure.

The portion of the user's body with which the intimate contact surface portion of the outer surface of the enclosure of the wearable device is brought into intimate contact is a portion other than the intended portion which should receive or emit acoustic signals. Where intimate contact with this portion is made, there is a danger that propagation of acoustic signals is hindered. Where the electroacoustic converter converts an acoustic signal into an electrical signal such as a loudspeaker, the user's body is a portion other than user's ears. Where the electroacoustic converter converts an electrical signal into an acoustic signal such as-a microphone, the user's body is a portion other than user's mouth.

In the wearable electronic device of the invention, (1) acoustic signal surface propagation path formation means constituting the acoustic signal propagation path formation means can be formed on the surface portion of the enclosure that is brought into intimate contact with the user's body (hereinafter may be referred to as a first mode of practice or first aspect). (2) The enclosure can be made up of an enclosure body portion and a cover portion. Acoustic signal inner propagation path formation means constituting the acoustic signal propagation path formation means can be formed between the body portion of the enclosure and the cover portion (hereinafter may be referred to as a second mode of practice or second aspect).

More specifically, in the wearable electronic device according to the first mode of practice of the invention, the enclosure has an acoustic hole extending through the wall portion of the enclosure between the inner surface of the electroacoustic converter and the intimate contact surface portion, the inner surface surrounding the electroacoustic converter.

The acoustic signal propagation path formation means includes the acoustic hole and acoustic signal surface propagation path formation means formed in the outer surface of the enclosure between the intimate contact surface portion around the opening portion of the acoustic hole and the exposed surface portion facing the outside environment to permit propagation of acoustic signals along the surface portion between the opening portion of the acoustic hole in the intimate contact surface portion and the outside environment when the device is mounted to the user's body and the intimate contact surface portion is placed in intimate contact with the surface of the user's body.

In other words, according to the first mode of practice of the invention, the wearable electronic device of the invention is a wearable electronic device having the electroacoustic converter incorporated in the enclosure and the acoustic hole extending through the wall portion between the inner surface of the enclosure surrounding the electroacoustic converter and the outer surface that touches the user' body when mounted, in order to achieve the above-described object. The wearable device is used while the enclosure is mounted to the user's body. The enclosure has the acoustic signal surface propagation path formation means that provides the acoustic signal surface propagation path permitting propagation of acoustic signals along the surface portion of the outer surface around the opening portion of the acoustic hole between the opening portion of the acoustic hole and the outside environment when the enclosure is mounted to the user's body and the surface portion comes into contact with the user's body.

In the wearable electronic device according to the first mode of practice of the invention, the electroacoustic device is mounted within the enclosure. The acoustic hole is formed which extends through the wall portion of the enclosure between the inner surface surrounding the electroacoustic converter and the outer surface that is placed in contact with the user's body during mounting. Therefore, propagation of acoustic signals between the electroacoustic converter and the outside environment is done via the acoustic hole extending through the wall portion of the enclosure. The wearable electronic device of the invention is especially characterized in that “the enclosure has the acoustic signal propagation path formation means that provides the acoustic signal propagation path permitting propagation of acoustic signals between the opening portion of the acoustic hole and the outside environment in the surface portion of the outer surface of the enclosure around the opening portion of the acoustic hole which touches the user's body during mounting when the enclosure is mounted to the user's body and the surface portion touches the user's body”. Therefore, even where the wearable electronic device is mounted to the user's body and the enclosure of the wearable device is in intimate contact with the surface of the user's body, the acoustic signal surface propagation path formation means secures the acoustic signal surface propagation path along which acoustic signals are propagated, between the opening portion of the acoustic hole and the outside environment. Any blockage or attenuation hindering propagation of acoustic signals between the electroacoustic converter and the outside environment can be circumvented. Accordingly, where the electroacoustic converter is a converter of the type for converting an electrical signal into an acoustic signal such as a loudspeaker, the acoustic signal surface propagation path formation means permits acoustic signals from the electroacoustic converter to propagate to the outside environment via the acoustic signal surface propagation path formed between the surface of the user's body and the outside environment even where the wearable device is mounted to the user's body and the enclosure of the device is in intimate contact with the user's body. Then, the signal reaches the user's ear. Where the electroacoustic converter is a converter of the type for converting an acoustic signal into an electrical signal such as a microphone, acoustic signals such as speech uttered by the user can be propagated to the electroacoustic converter such as a microphone via the acoustic signal surface propagation path formed by the acoustic signal surface propagation path formation means between the outside environment and the surface of the user's body even where the wearable device is mounted to the user's body and the enclosure of the device is in intimate contact with the surface of the user's body. Then, the signal is converted into an electrical signal. Consequently, in the wearable electronic device of the invention, radiation or reception of sound is done reliably.

In the wearable electronic device according to the first mode of practice of the invention, the acoustic signal surface propagation path formation means includes concave or convex portions formed on or in the outer surface portion. That is, the acoustic signal surface propagation path formation means can be discretely formed concave or convex portions formed on or in the outer surface or groove portions formed in the outer surface portion. Concave, convex, and groove portions may be present in combination.

Where the acoustic signal surface propagation path formation means includes plural convex portions discretely formed on the outer surface portion, the acoustic signal surface propagation path consists of concave portions formed between the discrete convex portions in the space between the discrete convex portions and the surface of the user's body that contacts the convex portions. That is, acoustic signals are propagated via the concave portions formed between the discrete convex portions having protruding portions that touch the surface of the user's body.

The discrete convex portions may be shaped or arranged at will as long as they permit propagation of acoustic signals via the concave portions relatively formed between the convex portions. Typically, they are arc-shaped, for example. In this case, the convex portions forming arcs may be relatively thin arc-shaped lines or relatively thick arc-shaped lines (e.g., sector-shaped). As for the discrete convex portions, a large number of convex portions may be dispersed or distributed instead of arc-shaped portions. In this case, each convex portion is typically a dome-shaped form, although other shapes are also possible. Where the electroacoustic converter is made of a loudspeaker and the acoustic signal surface propagation path formation means consists of discrete convex portions, the convex portions may be preferably limited to a narrow range around the opening portion of the sound radiation hole such that the region where the discrete convex portions formed on the outer surface portions around the sound radiation hole for the speaker are distributed is located inside the region of the outside surface portion that touches the user's ear. In this case, when the wearable device is attached to the ear and used, leakage of sound (sound spreading to the surroundings as noise) radiated out from the speaker through the sound radiation hole can be suppressed to a minimum.

Where the acoustic signal surface propagation path formation means includes groove portions formed in the surface portions, the groove portions typically extend to the fringes of the outer surface so as to connect the opening portion of the acoustic hole and the fringes of the outer surface.

More specifically, in the wearable electronic device according to the second mode of practice of the invention, the enclosure consists of an enclosure body portion and a cover portion. The enclosure body portion has a body inner surface surrounding the electroacoustic converter to define the inner surface of the enclosure. An acoustic hole extending through the wall portion of the enclosure body portion is formed between the body inner surface and the body outer surface opposite to the body inner surface. The cover portion includes a cover outer surface and a cover intimate contact surface portion which define the cover outer surface and the cover intimate contact surface portion, respectively, of the enclosure. The cover portion is mounted to the enclosure body portion so as to cover a region including the opening portion of the acoustic hole of the body outer surface. When the cover intimate contact surface portion of the cover outer surface is so mounted as to make intimate contact with the surface of the use's body, an acoustic signal inner propagation path permitting propagation of acoustic signals between an exposed surface portion and the acoustic hole opening portion of the body outer surface is formed between the body outer surface and the portion of the cover portion that is opposite to the body outer surface. The exposed surface portion moves off the surface of the user's body and faces the outer environment when the cover intimate contact surface portion of the cover outer surface is so mounted that it is placed in intimate contact with the surface of the user's body.

In other words, according to the second mode of practice of the invention, the wearable electronic device according to the invention is a wearable electronic device that has an electroacoustic device, an enclosure having an enclosure body portion, and a cover portion, in order to achieve the above-described object. The enclosure body portion has a body inner surface surrounding the electroacoustic converter and an acoustic hole extending through the wall portion of the enclosure body portion between the body inner surface and a body outer surface on the opposite side of the body inner surface. The cover portion has a cover outer surface including a cover intimate contact surface portion-placed in intimate contact with the surface of the user's body during mounting. The cover portion is mounted to the enclosure body portion so as to cover a region of the body outer surface which includes the opening portion of the acoustic hole. When the wearable device is mounted in such a way that the cover intimate contact surface portion of the cover outer surface is placed in intimate contact with the surface of the user's body, acoustic signal inner propagation path formation means providing an acoustic signal inner propagation path permitting propagation of acoustic signals between an exposed surface portion and the opening portion of the acoustic hole in the body outer surface is formed between the body outer surface and the portion of the cover portion that faces the body outer surface. The exposed surface portion is moved off the surface of the user's body and faces the outside environment when the device is mounted as described above.

In this case, the acoustic signal propagation path is the acoustic signal inner propagation path formed between the cover portion and the enclosure body portion. Therefore, even where the wearable electronic device is mounted to the body such as an arm, the propagation path is not in contact with the surface of the body. Consequently, it is hardly likely that the propagation path is plugged up by dirt due to sweat or by dust.

Furthermore, since the acoustic signal inner propagation path is formed between the cover portion and the enclosure body portion, the orientation and route of the inner propagation path can be set at will by the cover portion and the enclosure body portion, irrespective of the position and orientation of the acoustic hole. The propagation path may take radial, arc-shaped, curved, or any other desired form. The propagation path may extend in a two-dimensional manner or be bent in a three-dimensional manner.

The cover portion is typically made of a soft rubber such as silicone rubber or a soft plastic material such as urethane. Where the electroacoustic converter consists of a loudspeaker or the like, if it is held with a hand and directly held against the ear, a high degree of intimate contact is obtained and sound can be easily heard. Where the device is mounted to an arm, the device fits well. Where desired, the cover portion may be made of a relatively hard material.

The acoustic signal inner propagation path formation means may include convex portions formed on at least one of the body outer surface and the cover inner surface. Also, the formation means may include groove portions formed in at least one of the body outer surface and the cover inner surface.

In the wearable electronic device of the invention, the electroacoustic device may be a microphone, a loudspeaker, or both a microphone and a loudspeaker.

The wearable electronic device of the invention incorporates cell phone functions, for example. Furthermore, the wearable electronic device according to the invention is an arm-mounted type whose enclosure is mounted to an arm, for example. Note that the wearable electronic device may be mounted to other than wrists such as neck, head, and upper arm to be used. The wearable electronic device may be provided with only an electroacoustic converter radiating out acoustic signals such as a radio set or various kinds of players or with only an electroacoustic converter receiving acoustic signals such as recording apparatus.

### BRIEF DESCRIPTION OF THE DRAWINGS

FIG. 1A is a plan view of a wristwatch type personal digital assistant (PDA) acting as a wearable electronic device according to Embodiment 1 of the invention in an open position where the PDA has been detached from the arm;

FIG. 1B is a side elevation of the PDA shown in FIG. 1A;

FIG. 1C is a view illustrating the inner side (rear surface) of the PDA shown in FIG. 1A;

FIG. 1D is a side elevation of the PDA shown in FIG. 1A, and in which the PDA is worn on an arm (wrist);

FIG. 2A is a plan view illustrating the inner side of a sound radiation portion of the PDA shown in FIG. 1A;

FIG. 2B is a side elevation of the sound radiation portion shown in FIG. 2A;

FIG. 2C is a cross-sectional view taken on line IIC-IIC of FIG. 2A;

FIG. 3A is a plan view illustrating the inner side of a sound reception portion of the PDA shown in FIG. 1A;

FIG. 3B is a side elevation of the sound reception portion shown in FIG. 3A;

FIG. 3C is a cross-sectional view taken on line IIIC-IIIC of FIG. 3A;

FIG. 4 is a side elevation illustrating the state of operation of the PDA shown in FIGS. 1A-1D;

FIG. 5A is a plan view of a sound radiation portion of a device according to Embodiment 2 of the invention, illustrating the inner side;

FIG. 5B is a side elevation of the sound radiation portion shown in FIG. 5A;

FIG. 5C is a cross-sectional view taken on line VC-VC of FIG. 5A;

FIG. 6A is a plan view of a sound reception portion of the device according to Embodiment 2, illustrating the inner side;

FIG. 6B is a side elevation of the sound reception portion shown in FIG. 6A;

FIG. 6C is a cross-sectional view taken on line VIC-VIC of FIG. 6A;

FIG. 7A is a plan view of a sound radiation portion of a device according to Embodiment 3, illustrating the inner side;

FIG. 7B is a side elevation of the sound radiation portion shown in FIG. 7A;

FIG. 7C is a cross-sectional view taken on line VIIC-VIIC of FIG. 7A;

FIG. 8A is a plan view of a sound reception portion of the device according to Embodiment 3, illustrating the inner side;

FIG. 8B is a side elevation of the sound reception portion shown in FIG. 8A;

FIG. 8C is across-sectional view taken on line VIIIC-VIIIC of FIG. 8A;

FIG. 9 is a side elevation illustrating the state of operation of the device according to Embodiment 3;

FIG. 10A is a plan view of a sound radiation portion of a device according to Embodiment 4, illustrating the inner side;

FIG. 10B is a side elevation of the sound radiation portion shown in FIG. 10A;

FIG. 10C is a cross-sectional view taken on line XC-XC of FIG. 10A;

FIG. 11A is a plan view of a sound reception portion of the device according to Embodiment 4, illustrating the inner side;

FIG. 11B is a side elevation of the sound reception portion shown in FIG. 11A;

FIG. 11C is a cross-sectional view taken on line XIC-XIC of FIG. 11A;

FIG. 12 is a side elevation illustrating the state of operation of the device according to Embodiment 4;

FIG. 13A is a plan view of a sound radiation portion of a device according to Embodiment 5, illustrating the inner side;

FIG. 13B is a side elevation of the sound radiation portion of FIG. 13A;

FIG. 13C is across-sectional view taken on line XIIIC-XIIIC of FIG. 13A;

FIG. 14A is a plan view of a sound reception portion of the device according to Embodiment 5, illustrating the inner side;

FIG. 14B is a side elevation of the sound reception portion shown in FIG. 14A;

FIG. 14C is a cross-sectional view taken online XIVC-XIVC of FIG. 14A;

FIG. 15 is a side elevation illustrating the state of operation of the device according to Embodiment 5;

FIG. 16 is a side elevation illustrating the state of operation of a device according to Embodiment 6;

FIG. 17 is an exploded perspective view of the device shown in FIG. 16, taken from the inner side (from the cover portion side), and in which a part of an enclosure body portion and a cover portion are shown to be exploded, the enclosure body portion and the cover portion together constituting the enclosure of a rigid band portion for attachment to an arm, the band portion having a speaker therein;

FIG. 18 is an exploded perspective view of the device shown in FIG. 16, taken from the outer side (from the side of the enclosure body portion), and in which apart of an enclosure body portion and a cover portion are shown to be exploded, the enclosure body portion and the cover portion together constituting the enclosure of a rigid band portion for attachment to an arm, the band portion having a speaker therein;

FIG. 19A is a plan view of the rigid band portion of the device shown in FIG. 16, taken from the direction indicated by the arrow XIXA of FIG. 19B, particularly showing the structure of the rigid band portion;

FIG. 19B is a side elevation taken from the direction indicated by the arrow XVIXB of FIG. 19A; and

FIG. 19C is a cross-sectional view taken on line XIXC-XIXC of FIG. 19A.

### DESCRIPTION OF THE PREFERRED EMBODIMENTS

Some preferred modes of practice of the present invention are hereinafter described in detail using preferred embodiments shown in the accompanying drawings.

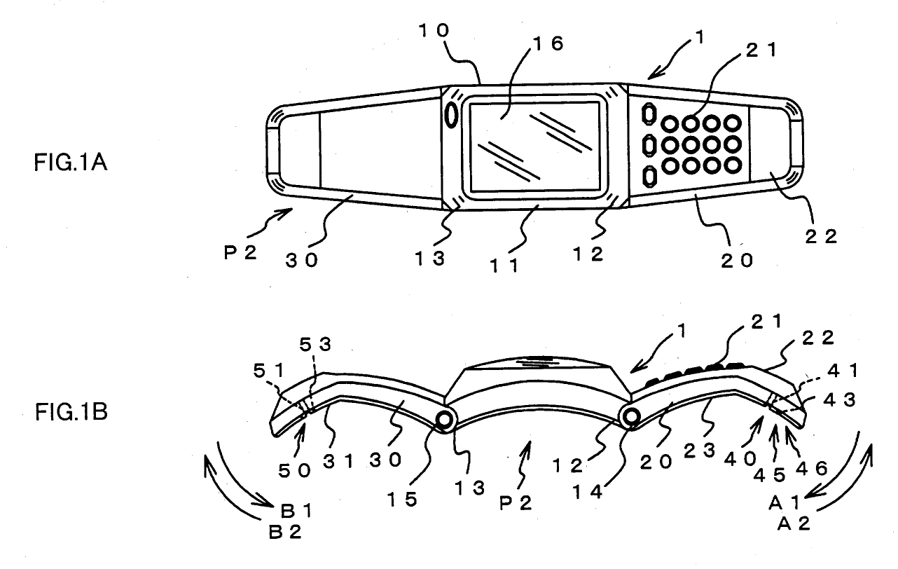

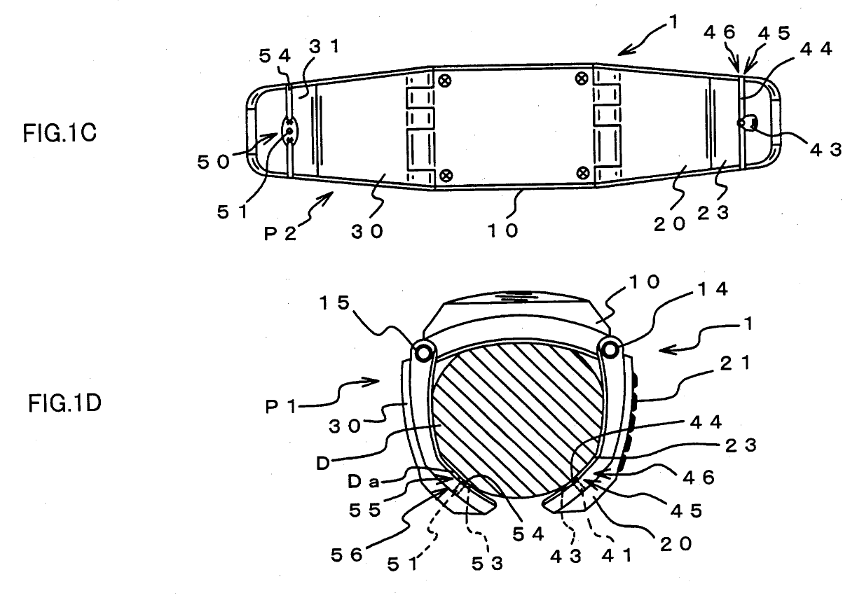

Referring to FIGS. 1-4, there is shown a wristwatch type personal digital assistant (PDA) 1 acting as a wearable electronic device according to preferred Embodiment 1 of the invention. The PDA 1 has cell phone functions. As can be seen from FIGS. 1A-1C, the PDA 1 has an electronic device body 10 including an enclosure portion 11 having opposite ends 12 and 13. The PDA 1 further includes rigid band portions 20 and 30 rotatably joined to the enclosure portion 11 so as to be rotatable about the axes of rotation 14 and 15 of the opposite ends 12 and 13, respectively, in the directions A1, A2 and B1, B2, respectively. The rigid band portions 20 and 30 typically are chiefly made of a relatively hard material to maintain the whole shape such that parts of an electronic device can be accommodated therein. However, the rigid band portions 20 and 30 are somewhat deformable. The electronic device body 10 is provided with a display portion 16 such as a liquid crystal panel. Various kinds of information are displayed on the display portion 16. This display portion 16 can have time display functions as a watch, for example.

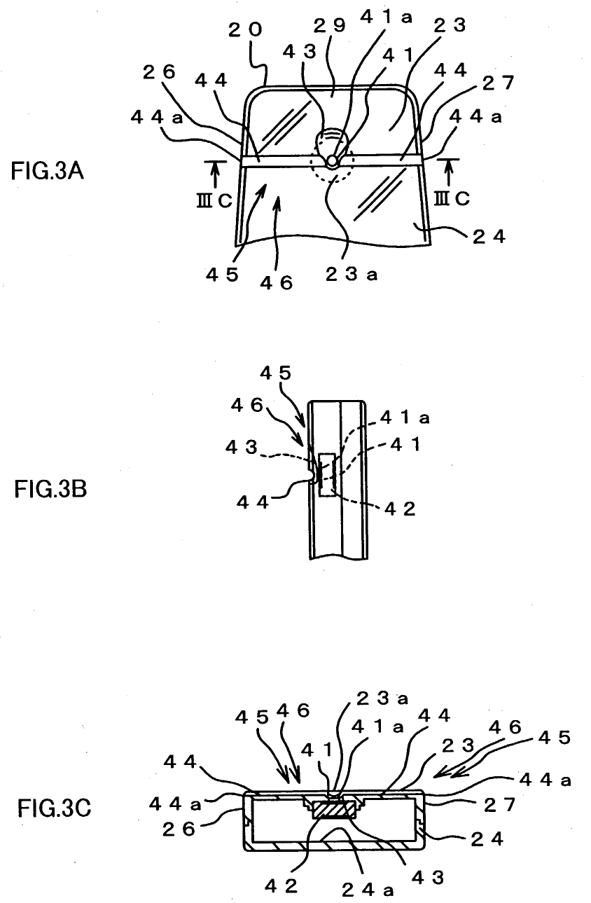

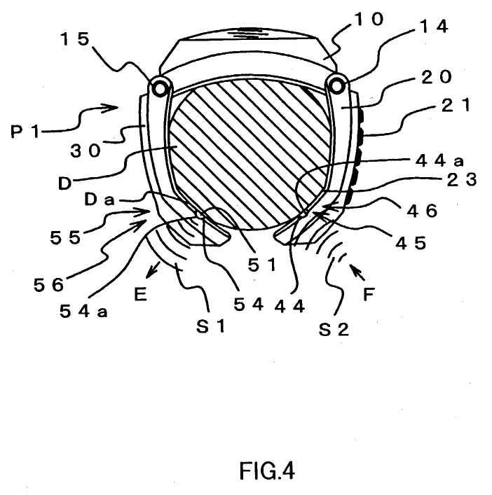

The rigid band portion 20 has a surface 22 on which an input operation portion 21 such as push buttons and key switches are installed. This band portion also has an outer surface 23 that is brought into contact with a wrist D of a user and has a sound reception portion 40 open through a sound reception hole 41. More specifically, as shown in FIGS. 3A-3C, the sound reception portion 40 performing sound-receiving functions in a cell phone or the like includes a microphone 42 positioned in an enclosure portion 24 of the rigid band portion 20, the sound reception hole 41 formed in the enclosure portion 24 between the inner surface 24a surrounding the microphone 42 and the outer surface 23 to transmit acoustic signals such as speech to the microphone 42 within the enclosure portion 24, a recessed portion 43, and groove portions 44. The recessed portion 43 and groove portions 44 are formed in the surface portions around the opening portion 41a of the sound reception hole 41 to conduct acoustic signals into the opening portion 41a of the sound reception hole 41. In particular, in this embodiment, the recessed portion 43 is formed around the whole periphery of the opening portion 41a of the sound reception hole 41 and biased toward an end 29 of the rigid band portion 20. The groove portions 44 extend laterally through the outer surface 23 to connect the recessed portion 43 with side surfaces 26 and 27 of the rigid band portion 20. When the PDA 1 assumes an installation position P1 as shown in FIGS. 1D and 4 and the outer surface 23 of the rigid band portion 20 touches the surface Da of the user's wrist D, the groove portions 44 cooperate with the recessed portion 43 to form or offer an acoustic signal surface propagation path 45 connecting the outside environment that the side surfaces 26 and 27 face and the sound reception hole 41 between the intimate contact surface portion 23a of the outer surface 23 and the surface Da of the wrist D. The side surfaces 26 and 27 act as exposed surface portions of the enclosure portion 24 of the rigid band portion 20 of the PDA 1. The sound reception hole 41 is placed in communication with the microphone 42. That is, the groove portions 44 and recessed portion 43 (more specifically, the surfaces or wall surfaces of the groove portions 44 and recessed portion 43) together constitute acoustic signal surface propagation path formation means 46. The sound reception hole 41 and the acoustic signal surface propagation path formation means 46 together form acoustic signal propagation path formation means 91. The groove portions 44 may extend obliquely to each other instead of being positioned in line as long as extension ends 44a open into the outside environment in the installation position P1. One of the groove portions 44 may be omitted. Furthermore, more groove portions 44 may be formed radially relative to the sound radiation hole 41.

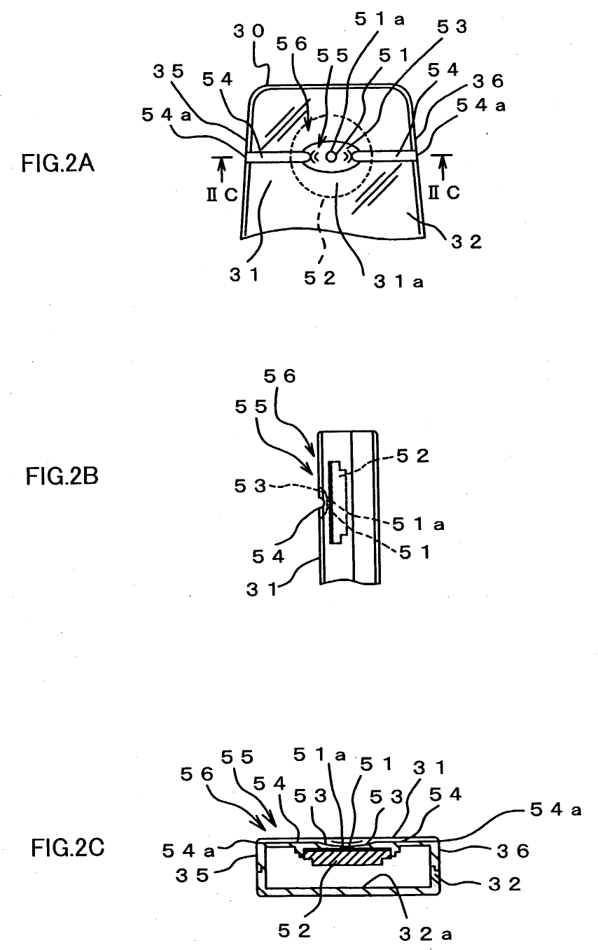

On the other hand, the rigid band portion 30 cooperating with the rigid band portion 20 to permit attachment of the electronic device body 10 onto the user's wrist D has a sound radiation portion 50 on the side of the outer surface 31. The sound radiation portion 50 is open through its sound radiation hole 51. Specifically, as shown in FIGS. 2A-2C, the sound radiation portion 50 performing sound radiation functions in a cell phone or the like includes a speaker 52 positioned inside the enclosure portion 32 of the rigid band portion 30, the radiation hole 51, a recessed portion 53, and groove portions 54. The radiation hole 51 is formed in the enclosure portion 32 between the inner surface 32a surrounding the speaker 52 and the outer surface 31 to permit acoustic signals from the speaker 52 to be radiated out from the enclosure portion 32. The recessed portion 53 and groove portions 54 are formed in the surface portion around the opening portion 51a of the sound radiation hole 51 to guide the acoustic signals from the opening portion 51a of the sound radiation hole 51. More specifically, in this embodiment, the recessed portion 53 is formed in the outer surface 31 like a loudspeaker around the opening portion 51a of the sound radiation hole 51 to transmit the acoustic signals from the opening portion 51a of the sound radiation hole 51 in a wide derection. The groove portions 54 extend laterally through the outer surface 31 so as to connect the recessed portion 53 with the side surfaces 35 and 36 acting as exposed surface portions of the rigid band portion 30. Accordingly, when the PDA 1 assumes the installation position P1 shown in FIGS. 1D and 4 and the outer surface 31 of the rigid band portion 30 touches the surface Da of the user's wrist D, the groove portions 54 cooperate with the recessed portion 53 to form or offer an acoustic signal surface propagation path 55 that places the sound radiation hole 51 in communication with the outside environment between the intimate contact surface portion 31a of the outer surface 31 and the surface of the wrist. That is, the groove portions 54 and recessed portion 53 (more specifically, the surfaces or wall surfaces of the groove portions 54 and recessed portion 53) together constitute acoustic signal surface propagation path formation means 56. The sound radiation hole 51 and acoustic signal surface propagation path formation means 56 together form acoustic signal propagation path formation means 92. The groove portions 54 may extend obliquely to each other instead of being positioned in line as long as extension ends 54a open into the outside environment in the installation position P1. One of the groove portions 44 may be omitted. Furthermore, more groove portions 54 may be formed radially relative to the sound radiation hole 51.

With the wristwatch type PDA 1 constructed as described above, the rigid band portions 20 and 30 are normally rotated relative to the electronic device body 10 in the directions A1 and B1, and the PDA assumes the installation position P1 where the device surrounds the user's wrist D, as shown in FIG. 1D. As the need arises, the rigid band portions 20 and 30 are rotated relative to the electronic device body 10 in the directions A2 and B2, and the open position P2 as shown in FIGS. 1A-1C is taken. The enclosure of the PDA 1 consists of the enclosure portion 11 of the electronic device body 10 and the enclosure portions 24, 32 of the rigid band portions 20, 30.

The wristwatch type PDA 1 can act as a cell phone while attached to the user's wrist D. In particular, as shown in FIGS. 1D and 4, when a telephone conversation is made while the PDA 1 remains in the installation position P1, the user enters the telephone number or the like of the called party with the input operation portion 21 and thus performs an operation for telephone conversation. At this time, acoustic signal S1 from the speaker 52 passes through the sound radiation hole 51 and is radiated out into the outside environment in direction E because of the presence of the recessed portion 53 and groove portions 54 in the outer surface 31 of the rigid band portion 30 acting as the acoustic signal propagation path formation means 56, i.e., via the acoustic signal surface propagation path (route or gap) 55 formed between the surface Da of the user's wrist D and the intimate contact surface portion 31a of the outer surface 31 of the rigid band portion 30. Similarly, user's speech S2 reaches the sound reception hole 41 via the acoustic signal surface propagation path (route or gap) 45 formed between the surface Da of the user's wrist D and the intimate contact surface portion 23a of the outer surface 23 of the rigid band portion 20 because of the presence of the groove portions 44 and recessed portion 43 in the outer surface 23 of the rigid band portion 20 acting as the acoustic signal surface propagation path formation means 46. The speech can reach the microphone 42 via the sound reception hole 41. Therefore, even where the PDA 1 is kept attached to the user's wrist D, it is assured that acoustic signals S1 and S2 go in and out of the speaker 52 and microphone 42 via the acoustic signal surface propagation paths 45 and 55. During conversation, a propagation path for sound waves and sound pressure is secured. During hands-free conversation, the conversional quality (i.e., quality of acoustic signals) is maintained high. In this PDA 1, the acoustic signal surface propagation path formation means 46 and 56 are formed by the groove portions 44, 54 and recessed portions 43, 53. Therefore, if dust or dirt adheres, it is easy to remove it. Consequently, the PDA can be operated stably for a long period.

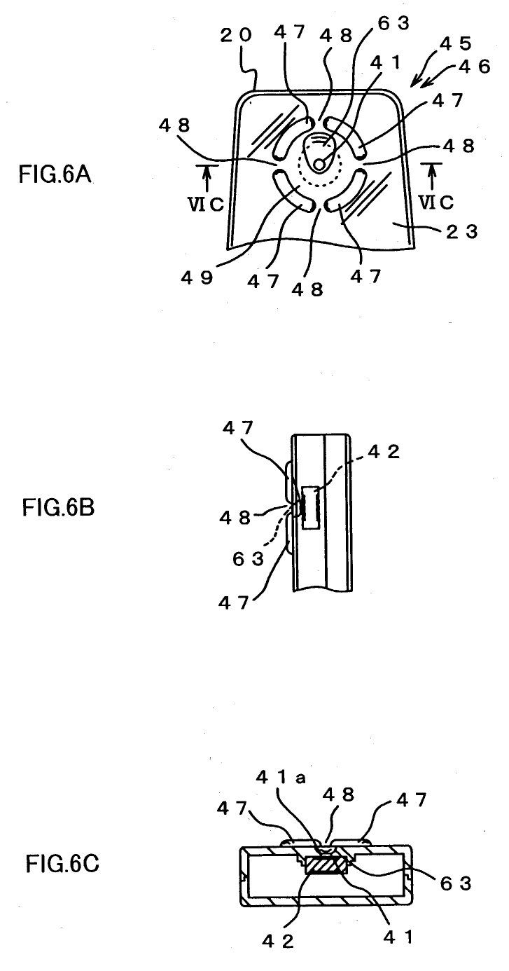

The acoustic signal surface propagation path formation means 46 formed in the rigid band portion 20 as described thus far may be discretely formed plural convex portions 47 protruding on the outer surface 23 instead of the groove portions 44 formed in the outer surface 23. In this case, the convex portions 47 are shaped into arc-shaped form as shown in FIGS. 6A-6C, and gaps or recessed portions 48 are relatively formed between the adjacent arc-shaped convex portions 47. Concave or space portions 49 permitting propagation of acoustic signals are formed between the arc-shaped convex portions 47 and concave portions 63.

Accordingly, even where the rigid band portion 20 is set in the installation position P1 and the top portions of the convex portions 47 are in intimate contact with the surface of the user's wrist D in the same way as in FIGS. 1D and 4 already described, the concave portions 48 acting as gaps between the adjacently positioned convex portions 47, space portion 49, and concave portions 63 cooperate with each other, thus securing a propagation path for acoustic signals. This assures that acoustic signals such as speech pass to the sound reception hole 41 via the concave portions 48 between the convex portions 47, space portion 49, and concave portions 63 and then to the microphone 42.

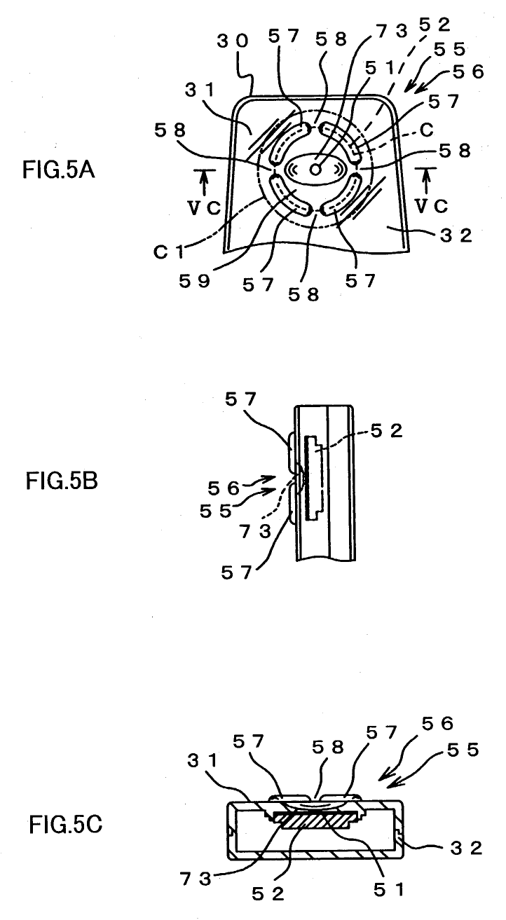

Similarly, the acoustic signal surface propagation path formation means 56 formed in the rigid band portion 30 may be discretely formed plural convex portions 57 so as to protrude on the outer surface 31 instead of the groove portions 54 formed on the outer surface 31. In this case, the convex portions 57 are shaped into arc-shaped form as shown in FIGS. 5A-5C. Gaps or concave portions 58 are relatively formed between the adjacent arc-shaped convex portions 57. Spaces portions 59 permitting propagation of acoustic signals are formed between the arc-shaped convex portions 57 and concave portions 73.

Accordingly, in the same way as in FIGS. 1D and 4 already described, even where the rigid band portion 30 is set in the installation position P1 and the top portions of the convex portions 57 are in intimate contact with the surface Da of the user's wrist D, the recessed portions 58 acting as gaps between the adjacently positioned convex portions 57, space portions 59, and recessed portions 73 cooperate to retain the propagation path for acoustic signals. Therefore, acoustic signal S1 radiated out from the speaker 52 and emitted from the sound radiation hole 51 is certainly radiated out into the outside environment in the direction E via the space portions 59 and recessed portions 58 between the adjacent convex portions 57. In consequence, the user can certainly hear the acoustic signal S1 from the speaker 52. In this case, by making the size of a circle C created by a set of arc-shaped convex portions 57 (in the embodiment of FIG. 5A, it is coincident with a broken line indicating the speaker 52 by chance) smaller than an area C1 (an area indicated by the phantom line in FIG. 5A) that touches the user's ear, the whole periphery of the outer surface 31 can be brought into contact with the user's ear when the user makes a telephone conversation while attaching the sound radiation portion 50 to his ear in the same way as where the user utilizes a cell phone in a normal manner. In this case, leakage of sound into the outside via groove portions can be prevented because the outer surface 31 does not have the groove portions 54, compared with the case of FIG. 1.

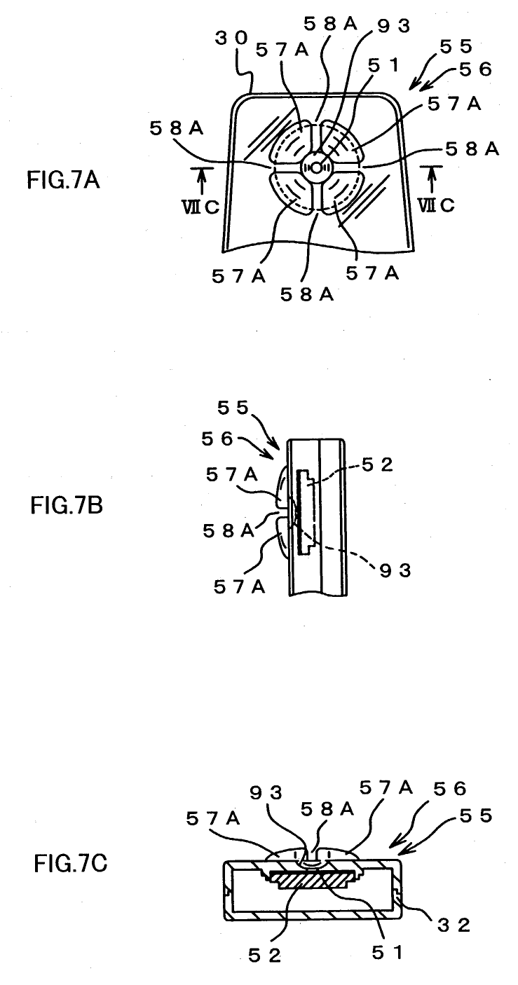

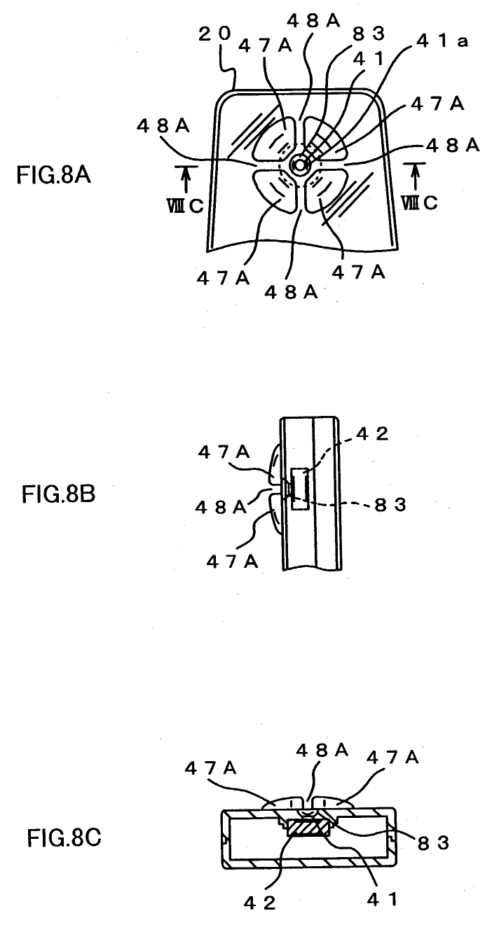

The convex portions forming the acoustic signal surface propagation path formation means 46 and 56 can be substantially sector-shaped (thick arc-shaped) convex portions 47A or 57A as shown in FIGS. 8, 7, or 9, instead of the arc-shaped convex portions 47 or 57 shown in FIG. 6 or 5. In this case, the convex portions 48A or 58A provide an increased surface area in contact with the surface Da of the user's wrist D. This reduces the pushing force per unit area that the user receives from the convex portions 47A or 57A. Therefore, it is hardly likely that the user undergoes a sense of oppression on the mounting portion. In this case, however, since the concave portions 48A or 58A becoming gaps between the adjacent convex portions 47A or 57A substantially assume the form of an elongated acoustic signal propagation path, propagating acoustic signals easily attenuate. Therefore, it is noted that the gaps are sometime set wider. The inner fringes of the convex portions 47A or 57A may or may not reach concave portions 83 or 93 of the microphone 42 or the speaker 52 as shown in the drawings.

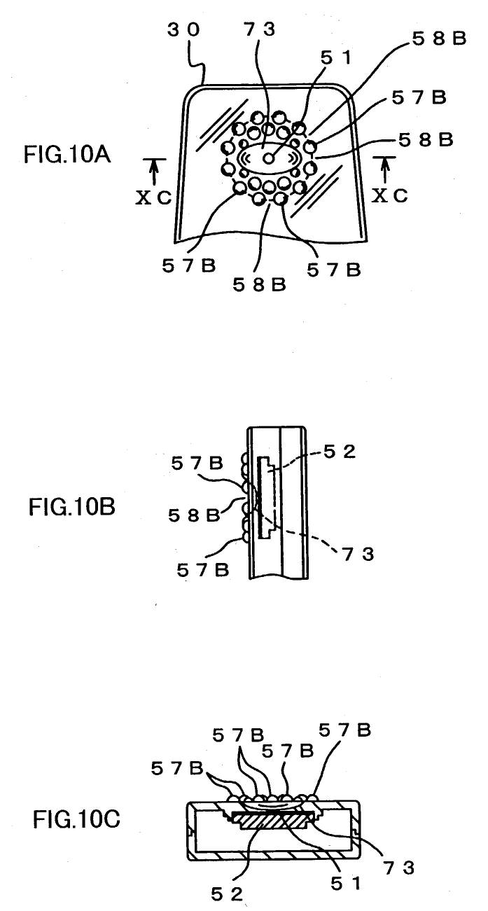

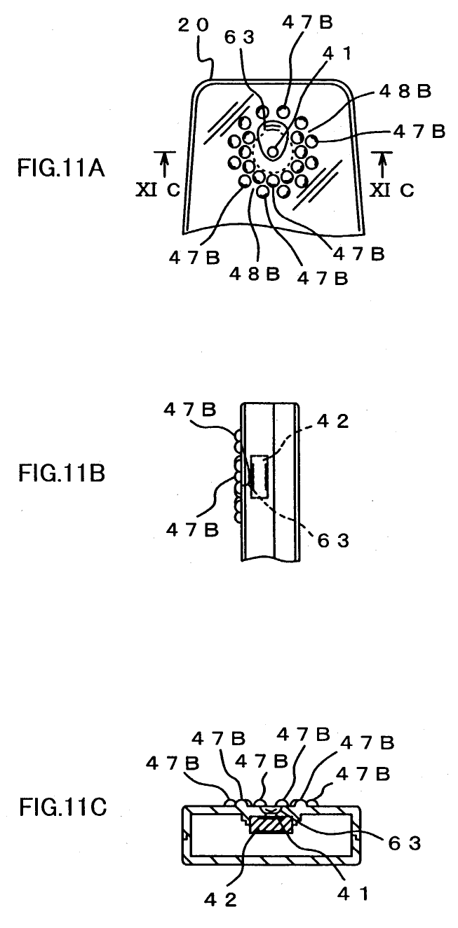

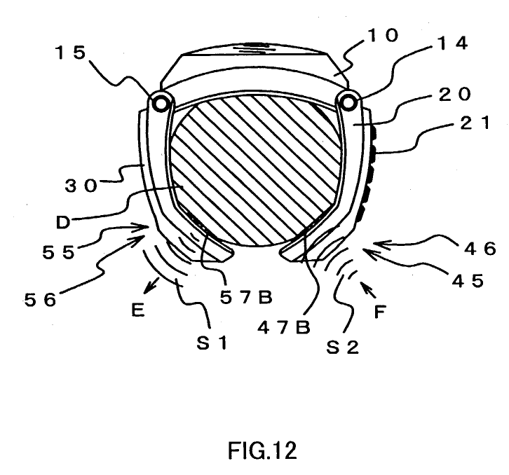

The convex portions forming the acoustic signal surface propagation path formation means 46 and 56 may be a large number of semispherical or dome-shaped convex portions 47B or 57B tapering off as shown in FIG. 11, 10, or 12, instead of the arc- or sector-shaped form. In this case, the concave portions 48B or 58B, gaps between the adjacent convex portions 47B or 57B, provide a propagation path for acoustic signals. In the embodiment shown in FIGS. 11 and 10, the convex portions 47B and 57B are arranged concentrically, however, they may be distributed otherwise as desired. Although all the convex portions 47B and 57B may be identical in size or shape, convex portions that are different in size or shape may be used in combination, taking account of the size or route of the propagation path.

Where the acoustic signal surface propagation path formation means is made up of a multiplicity of convex portions 47B or 57B in this way, an appropriate gap is created with the surface of the skin of the user's wrist D. This enhances the air permeability. Hence, stickiness of the surface Da of the wrist D can be easily avoided. Furthermore, slippage relative to the wrist surface during mounting may be suppressed by appropriately selecting the size of the convex portions, their distribution, the shape of the front end of each convex portion, and the material.

In the description of the embodiments described thus far, the acoustic signal surface propagation path formation means 46 for receiving sound and the surface acoustic signal propagation path formation means 56 for sound radiation have identical groove portions or convex portions. Since the easiness of sound reception is different from the easiness of sound radiation, the acoustic signal surface propagation path formation means 46 for sound reception may take any one form of the above embodiments adapted for sound reception, and the acoustic signal surface propagation path formation means 56 for sound radiation may take other mode of the above embodiments adapted for sound radiation.

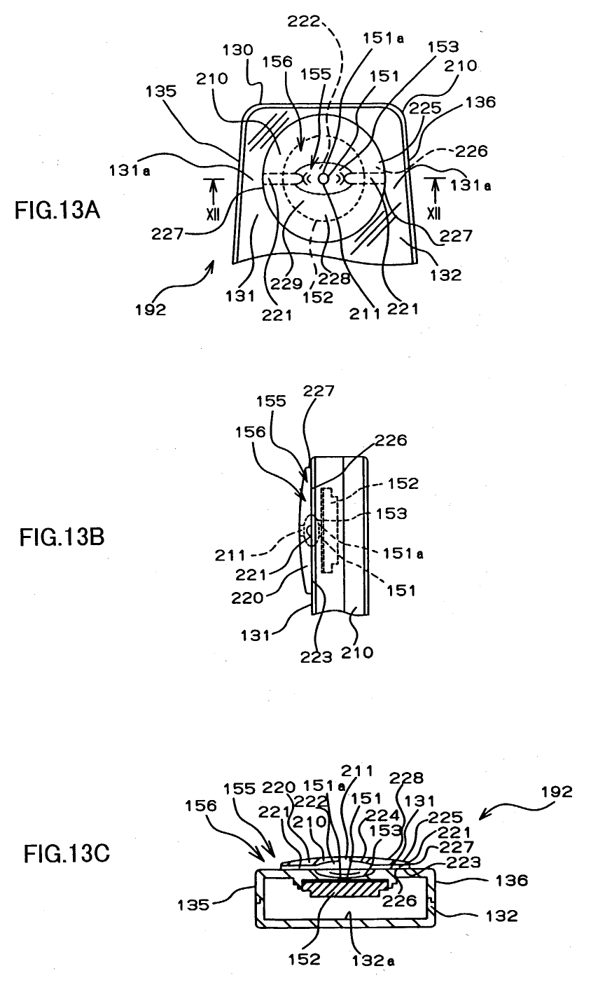

Some embodiments of the wearable electronic device according to the second mode of practice of the present invention are next described by referring to FIGS. 13-19.

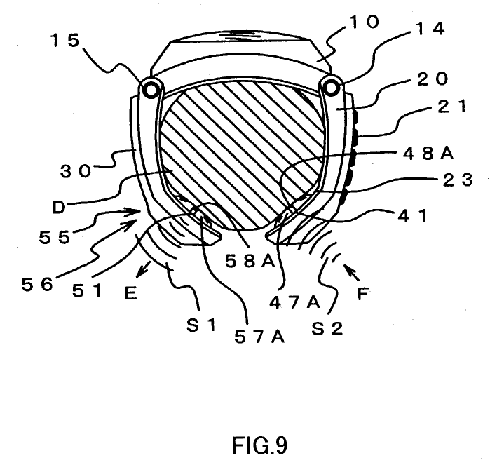

Referring next to FIGS. 13-15, there is shown a personal digital assistant (PDA) 101 acting as a wearable electronic device according to Embodiment 5 of the invention. In FIGS. 13-15, those components, parts, and elements which are identical with their counterparts of the embodiments already described in connection with FIGS. 1-12 are denoted by the identical symbols with addition of symbol “100”.

In the PDA 101, as shown in FIG. 13, the enclosure 210 of the rigid band portion 130 is made up of an enclosure portion acting as an enclosure body portion, i.e., an enclosure body portion 132 and a cover portion 220 made of soft rubber.

The enclosure body portion 132 is made similar to the enclosure portion 32 of Embodiment 1 shown in FIG. 2 except that no grooves are formed in the surface 131. The inner surface 132a of the body surrounds a speaker 152. A sound radiation hole 151 is formed between the inner surface 132a of the body and the outer surface 131 of the body. Grooves 221 becoming an acoustic signal inner propagation path 155 are formed in the cover portion 220.

The cover portion 220 takes the form of a low dome and has a recessed portion 224 on its inner surface 223 so as to form a domelike chamber 222 surrounding the opening portion 151a of the sound radiation hole 151 and a recessed portion 153 around it in the enclosure body portion 132. The cover portion 220 also includes an annular fringe portion 225 having a bottom surface 226. The cover portion 220 is placed in intimate contact with and fixed to the surface 131 of the enclosure body portion 132 at the bottom surface 226. In the embodiment shown in FIG. 13, the cover portion 220 is held with adhesive. Instead, the cover portion may be removably engaged.

The grooves 221 in the cover portion 220 are formed in the bottom surface 226 of the fringe portion 225 between the domelike recessed portion 224 and the outer surface 227 of the fringe portion 225 of the cover portion 220. This forms an acoustic signal inner propagation path 155 extending from the domelike chamber 222 where the opening portion 151a of the sound radiation hole 151 is present to an exposed surface portion 131a that is exposed to the outside. The acoustic signal inner propagation path formation means 156 is made up of the enclosure body portion 132 (more particularly, its outer surface 131), the cover portion 220 (more particularly, its annular bottom surface 226), the grooves 221, and the domelike recessed portion 224. That is, in this electronic device body or PDA body 110, the acoustic signal inner propagation path 155 is formed between the domelike cover portion 220 and the enclosure body portion 132. As shown in FIG. 15, the outer surface of the domelike cover portion 220, i.e., cover surface portion 228, is an outer surface having a surface portion placed into intimate contact with the surface Da of the user's wrist D, i.e., cover intimate contact surface portion 229. The top portion of the cover portion 220 is provided with a hole 211 acting as a sound radiation hole when the device is not mounted.

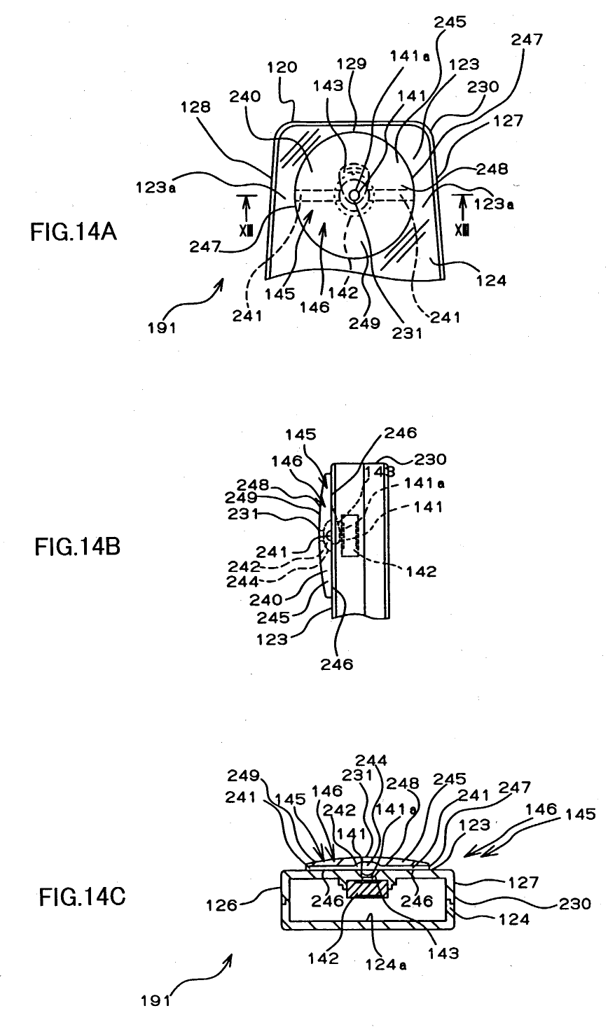

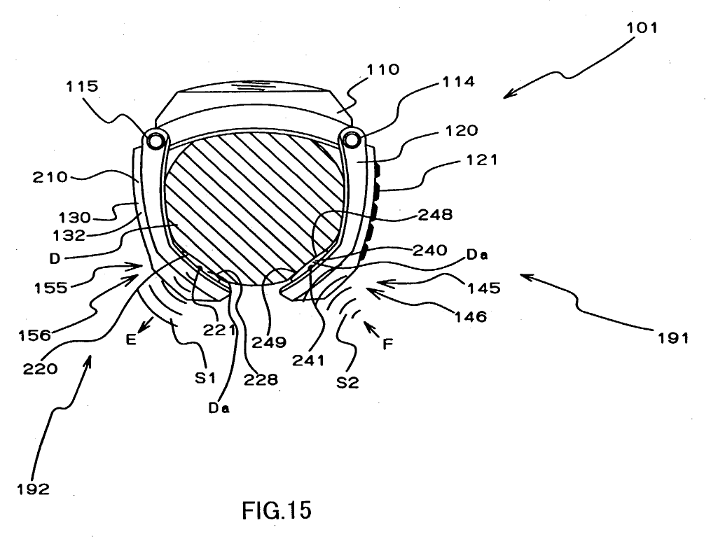

In the PDA 101, as shown in FIG. 14, the enclosure 230 of the rigid band portion 120 is made up of an enclosure portion acting as an enclosure body portion (i.e., the enclosure body portion 124) and a cover portion 240 made of soft rubber.

The enclosure body portion 124 is made similar to the enclosure portion 24 of Embodiment 1 shown in FIG. 3 except that no grooves are formed in its surface 123. The inner surface 124 of the body surrounds a microphone 142. A sound reception hole 141 is formed between the inner surface 124a of the body and the outer surface 123 of the body. Grooves 241 becoming an acoustic signal inner propagation path 145 are formed in the cover portion 240.

The cover portion 240 takes the form of a low dome and has a recessed portion 244 on its inner surface 243 so as to form a domelike chamber 242 surrounding the opening portion 141a of the sound radiation hole 141 and the recessed portion 143 around it in the enclosure body portion 124. The cover portion 240 also includes an annular fringe portion 245 having a bottom surface 246. The cover portion 240 is placed in intimate contact with and fixed to the surface 123 of the enclosure body portion 124 at the bottom surface 246. In the embodiment shown in FIG. 14, too, the cover portion 240 is held with adhesive. Instead, the cover portion 240 may be removably engaged.

The grooves 241 in the cover portion 240 are formed in the bottom surface 226 of the fringe portion 245 between the domelike recessed portion 244 and the outer surface 247 of the fringe portion 245 of the cover portion 240. This forms an acoustic signal inner propagation path 145 connecting the domelike chamber 242 into which the opening portion 141a of the sound radiation hole 141 opens with the exposed surface portion 123a exposed to the outer environment. The acoustic signal inner propagation path formation means 146 is made up of the enclosure body portion 124 (more particularly, its outer surface 123), the cover portion 240 (more particularly, its annular bottom surface 246), the grooves 241, and the domelike recessed portion 244. That is, in this electronic device body or PDA body 110, the acoustic signal inner propagation path 145 is formed between the domelike cover portion 240 and the enclosure body portion 124. As shown in FIG. 15, the outer surface of the domelike cover portion 240, i.e., the cover outer surface 248, is a surface portion placed in intimate contact with the surface Da of the user's wrist D, i.e., cover intimate contact surface portion 249. The top portion of the cover portion 240 is provided with a hole 231 acting as a sound radiation hole when the device is not mounted.

In the PDA 101 constructed as described above and acting as a wearable electronic device, when it is mounted to the user's wrist D in the state P1 as shown in FIG. 15, user's acoustic signal S2 is transmitted to the microphone 142 via the acoustic signal propagation path of the acoustic signal propagation path formation means 191 consisting of the groove 241 and the sound reception hole 141, the groove 241 constituting the acoustic signal inner propagation path formation means 145. In addition, acoustic signals emitted from the speaker 152 can be radiated out via the acoustic signal propagation path of the acoustic signal propagation path formation means 192 consisting of the sound radiation hole 151 and groove 221 forming the acoustic signal inner propagation path formation means 156.

In this case, the acoustic signal propagation path is composed of acoustic signal inner propagation paths 155 and 145 formed between the cover portions 220, 240 and the enclosure body portions 332, 324 and so if the wearable electronic device 101 is mounted to the body such as an arm, it is hardly likely that the propagation paths 155 and 145 are plugged up by dirt due to sweat or by dust.

In the above-described device, the cover portions 220 and 240 may be made of hard rubber or plastic material instead of soft rubber. Typically, the enclosure body portion is made of a plastic material. If desired, the enclosure body portion can be made of a metal.

Instead of forming the acoustic signal inner propagation paths 145, 155 in the junction portions of the cover portions 220 and 240, they may be chiefly formed in the junction portion of the enclosure body portion 332 with the cover portion. In this case, irregularities, for example, are formed in the junction surface of the enclosure body portion 332 to provide propagation paths.

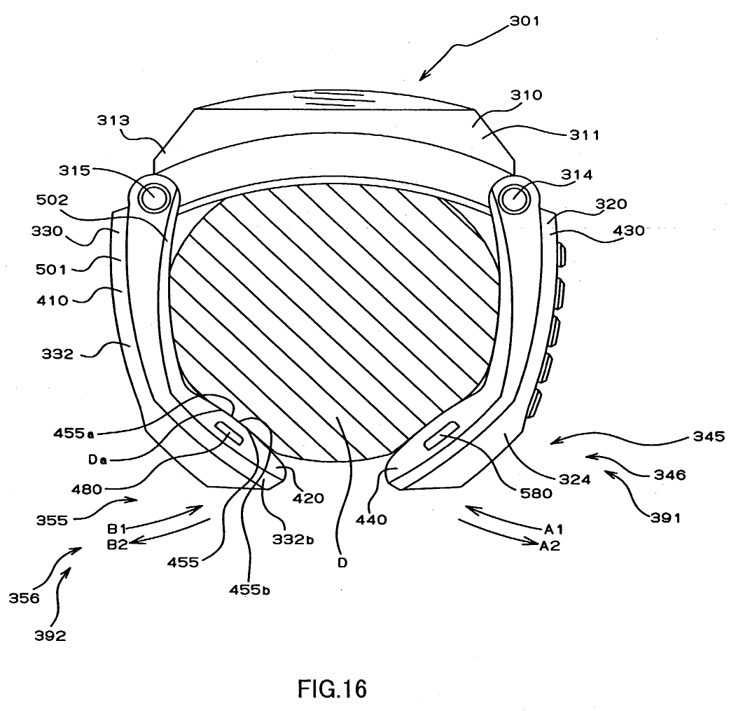

Obviously, the cover portions and enclosure body portion can take any shape and any structure as long as they provide intimate contact surface portions and exposed surface portions to permit propagation of acoustic signals via the acoustic signal propagation paths.

Where the enclosure is made up of the enclosure body portion and the cover portion, the acoustic signal inner propagation path may be partly, mostly, or totally formed in the cover portion instead of being formed in the portions where the enclosure body portion and cover portion are in contact or joined with each other or in the interfaces between them. Such an example is described as Embodiment 6 by referring to FIGS. 16-19.

In Embodiment 6 shown in FIGS. 16-19, those components, parts, and elements which are identical with their counterparts of Embodiment 5 already described in connection with FIGS. 13-15 are denoted by the identical symbols with addition of symbol “200”.

As shown in FIG. 16, a personal digital assistant (PDA) 301 serving as a wearable electronic device has an electronic device body or PDA body 310 and rigid band portions 320, 330 capable of moving relative to the electronic device body 310 in directions A1, A2 and B1, B2, respectively. The rigid band portions 320 and 330 have enclosures 430 and 410, respectively. The enclosure 430 of the rigid band portion 320 is composed of a rigid enclosure body portion 324 and a cover portion 440 made of soft rubber, the cover portion being removably mounted to the enclosure body portion 324. The enclosure 410 of the rigid band portion 330 is composed of an enclosure body portion 332 and a cover portion 420 made of soft rubber, the cover portion being removably mounted to the enclosure body portion 332.

The enclosures 410 and 430 are fundamentally similar in terms of acoustic signal propagation functions except for their unique shapes and structures for performing sound-receiving functions and sound-radiating functions, respectively. In the following description, the structure of the enclosure 410 performing sound-radiating functions is described in further detail by taking it as an example. The enclosure 430 can be constructed similarly to the enclosure 410 regarding the acoustic signal propagation functions except that sound-receiving functions are performed instead of sound-radiating functions and except for a structural difference responsive to the sensitivity of an electroacoustic converter. Therefore, the following description can be fundamentally applied to the enclosure 430 except for self-evident differences if sound radiation and sound reception are interchanged.

As can be seen from FIG. 16, the enclosure 410 includes a rigid enclosure body portion 332 that is shaped like a curved arm and a cover portion 420 made of rubber. The enclosure body portion 332 is mounted at its one end to an end 313 of the electronic device body 310 so as to be rotatable on its axis of rotation 315. The cover portion 420 is mounted to the concavely curved inner surface of the enclosure body portion 332 in a region close to the other end or front end 332b of the rigid enclosure body portion 332.

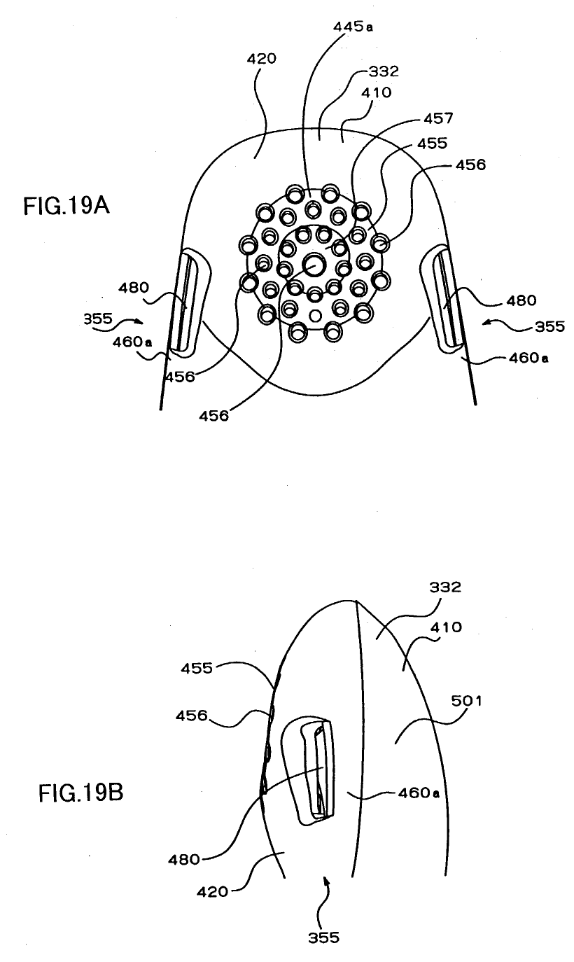

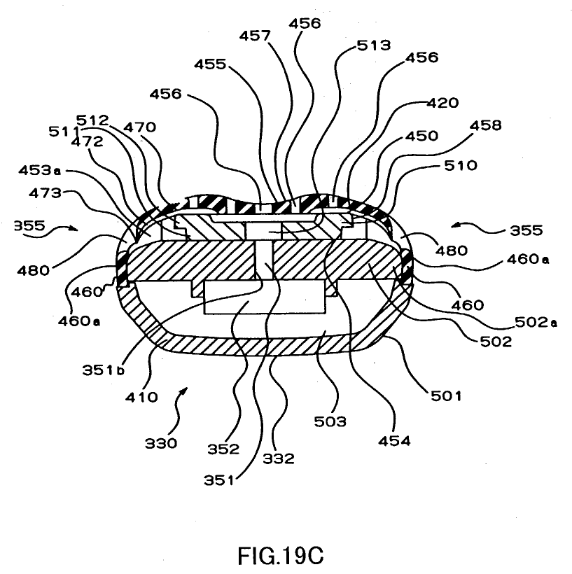

The enclosure body portion 332 includes a rigid case portion 501 on the outer side and a rigid case portion or rigid cover portion 502 on the inner side. As shown in FIG. 19C, a speaker 352 acting as an electroacoustic converter is disposed within an accommodation chamber 503 formed by a set of case portions 501 and 502. The outer surface of the chamber 503 is a body inner surface surrounding the speaker 352. A sound radiation hole 351 acting as an acoustic hole for transmitting acoustic signals emitted from the speaker 352 to the outside of the chamber 503 (i.e., the outside of the chamber 503 of the enclosure body portion 332) are formed in the rigid case portion 502 on the inner side.

The sound radiation hole 351 is formed in the inner-side rigid case portion 502 at the place which faces the speaker 352 rather than in the rigid case portion 501 on the outer side. Accordingly, when the PDA 301 is mounted to the wrist D, there is little danger that the sound radiation hole 351 is exposed to rainwater or the like. In addition, the aesthetic appearance of the rigid band portion 330 including the case portion 501 is not disfigured.

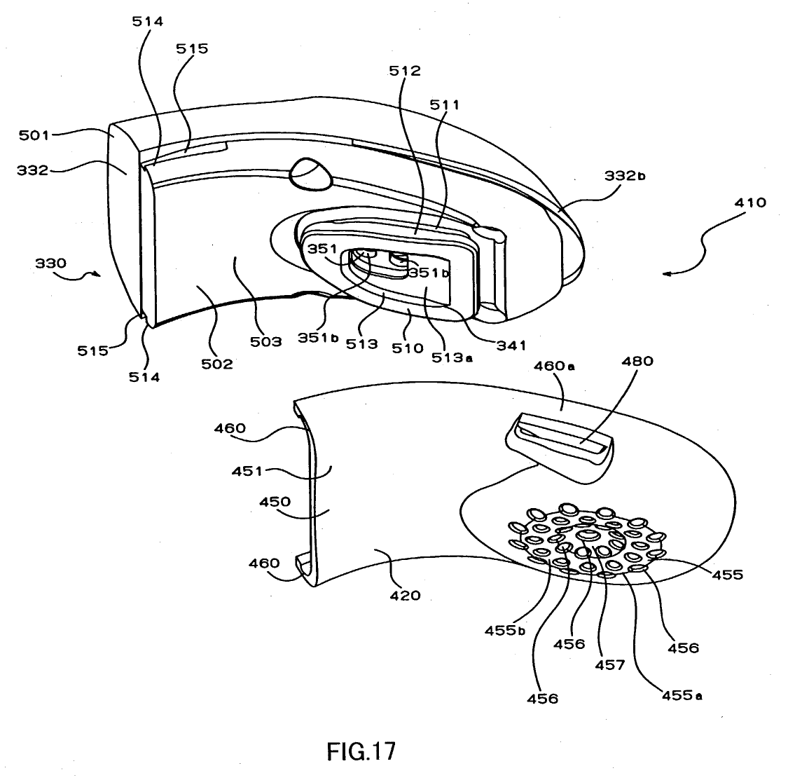

The inner-side rigid case portion 502 of the enclosure body portion 332 has a large cylindrical protruding portion 510 on its inner surface 503 in a region surrounding the sound radiation hole 351. In the embodiment shown in FIG. 19C, the protruding portion 510 is fabricated separately from the body portion 502a of the inner-side case portion 502 and they are firmly joined together. Of course, they can be fabricated as a unit. The cylindrical protruding portion 510 includes a cylindrical portion 511 on the base side and a flange-like engaging portion 512 at a protruding end. A large hole 513 in the center of the protruding portion 510 is continuous with base-side portions 351b of the sound radiation hole 351 to form a part of the sound radiation hole 351. In this embodiment, there are two base-side portions 351b (FIG. 17). As can be seen from FIG. 17, in the central hole 513 of the cylindrical protruding portion 510, the side surface on the front-end side is defined by a tilted wall portion 513a. The hole becomes wider as it goes toward the inner side.

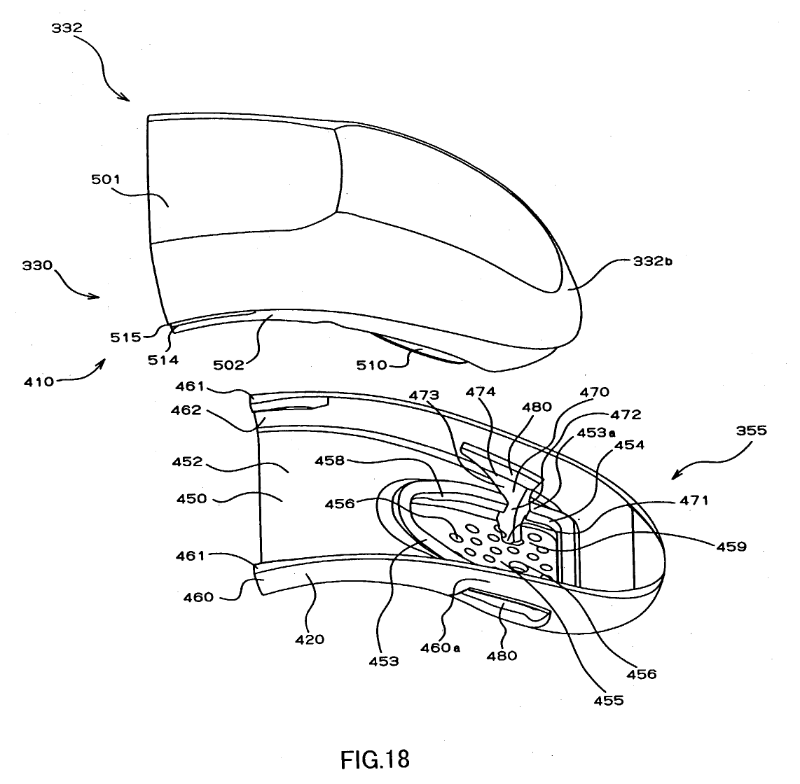

As can be seen from FIGS. 17 and 18, the rigid case portion or the rigid cover portion 502 on the inner side has an engaging protruding portion 514 and an engaging recessed portion 515 on its both sides in a region relatively remote from the front end portion 332b of the enclosure body portion 332. The engaging protruding portion 514 and engaging recessed portion 515 together act as engaging portions for removably holding the rubber cover portion 420 to a given location of the enclosure body portion 332, along with the flange-like engaging portion 512 and cylindrical portion 511 on the base side.

As shown in FIG. 16, the cover portion 420 made of rubber is removably attached to the inner side or rear side of the enclosure body portion 332 at the front end portion 332b of the enclosure body portion 332 of the rigid band portion 330 and in a given region close to the front end portion 332b.

As shown in FIGS. 17-19, the cover portion 420 made of rubber has a main wall portion 450 defining a main curved surface 451 located on the inner surface side and a side wall portion 460 extending along the fringes of the main wall portion 450. The main wall portion 450 has a cylindrical protruding portion 453 protruding inward from the inner surface 452 in a location where the main wall portion overlaps the cylindrical protruding portion 510 of the cylindrical body portion 332b. The part of the main wall portion 450 that becomes the end wall 455 of the central hole 454 in the cylindrical protruding portion 453 is provided with a number of small sound radiation holes 456 from which acoustic signals are radiated when the device is not mounted. The central portion of the end wall 455 is also curved to give a recessed portion 457 expanding like the inner surface of a speaker. A recessed portion 458 brought into engagement with a flange-like engaging portion 512 of the protruding portion 510 of the rigid case portion 502 is formed in the inner surface of the protruding end of the cylindrical protruding portion 453.

The side wall portion 460 of the cover portion 420 made of rubber has an engaging recessed portion 462 and a protruding portion 461 on the inner surface of an end portion of the side wall portion 460. The engaging recessed portion 462 and protruding portion 461 engage the engaging protruding portion 514 and engaging recessed portion 515 at the outer fringes of the inner-side rigid case portion 502 to permit the side wall portion 460 to suitably engage the inner-side rigid case portion 502 in a region remote from the front end portion 332b of the enclosure body portion 332b.

As can be seen from FIGS. 18 and 19C, the cover portion 420 made of rubber has a groove portion 470 extending through the wall portion 453a of the cylindrical protruding portion 453 from the center portion 459 of the side wall 455 of the central hole 454 in the cylindrical protruding portion 453, the groove portion 470 expanding its width toward the side wall portion 460 along the inner surface 452 of the main wall portion 450. The groove portion 470 includes a groove part 471 formed in the end wall 455, a groove part 472 formed in the cylindrical protruding portion 453 continuously with the groove part 471, and a groove part 473 formed in the inner surface 452 of the main wall portion 450 continuously with the groove part 472 between the cylindrical protruding portion 453 and the side wall portion 460. The part of the side wall portion 460 that is opposite to the end portion 474 of the groove part 473 of the groove portion 470 is provided with a through-hole or opening 480 continuously connected with the groove part 473. The outer surface portion of the side wall portion 460 to which the through-hole 480 opens forms an exposed cover surface portion 460a. In this embodiment, the groove portion 470 and through-hole 480 forming acoustic signal inner propagation path formation means 356 form or provide an acoustic signal inner propagation path 355. The acoustic signal propagation path formation means 392 is composed of the acoustic signal inner propagation path formation means 356 and sound radiation hole 351.

In the PDA 301 constructed as described thus far, in the installation state P1 where the rigid band portions 320 and 330 have been rotated and biased in the directions Al and B1 as shown in FIG. 16 and mounted to the user's wrist D, when acoustic signals are emitted from the speaker 352 (FIG. 19C), if the surface of the end wall portion 455 (i.e., the outer surface of the cover portion 420 made of rubber), that is, the central protruding portion (the portion around the recessed portion 457) of the cover outer surface 455a is brought as the cover intimate contact surface portion 455b into intimate contact with the surface Da of the user's wrist D and the small sound radiation holes 456 in the end wall portion 455 are plugged up by the wrist D, the acoustic signals can be radiated out from the opening portion 480 via the acoustic signal inner propagation path 355 formed between the cover portion 420 and enclosure body portion 332 by the groove portion 470 in the cover portion 420 and by the hole 480. This assures that the acoustic signals from the speaker 352 are heard by the user.

In the description provided thus far, the acoustic signal inner propagation path formation means 356 giving the acoustic signal inner propagation path 355 in the rigid band portion 330 has been explained. Obviously, sound reception by the microphone (not shown) can be similarly done with the rigid band portion 320 having the acoustic signal inner propagation path formation means 346 having an opening portion 580 similar to the opening portion 480 and fitted with the acoustic signal inner propagation path 345 formed by groove portions (not shown) similar to the groove portions 470 for the microphone placed in a position similar to that of the speaker 352.

In the above embodiment, the acoustic signal inner propagation path 355 is formed by the groove portion 470 in the cover portion 420 and the hole 480. However, parts of the acoustic signal inner propagation path 355 may be formed in the inner-side case 502 of the enclosure body portion 332, in particular, e.g., by forming groove portions in the protruding portion 510 of the inner-side case 502 or forming a through-hole in the cylindrical wall portion 511 of the protruding portion 510.

What is claimed is:

1. A wearable electronic device having an electroacoustic converter and an enclosure including an inner surface surrounding the electroacoustic converter and an outer surface, the outer surface including an intimate contact surface portion that is placed in intimate contact with a body surface of a user other than ears and mouth when the device is mounted, wherein
said enclosure has acoustic signal propagation path formation means providing an acoustic signal propagation path permitting propagation of acoustic signals such as speech between the inner surface and an exposed surface portion of the outer surface of the enclosure that is moved off the body surface of the user and faces the outer environment when the device is mounted.

2. The wearable electronic device of claim 1, wherein the enclosure has an acoustic hole extending through a wall portion of said enclosure between the inner surface surrounding the electroacoustic converter and said intimate contact surface portion, and
wherein said acoustic signal propagation path formation means includes said acoustic hole and acoustic signal surface propagation path formation means formed in the outer surface of said enclosure between the intimate contact surface portion around an opening portion of the acoustic hole and an exposed surface portion facing the outer environment to permit propagation of acoustic signals along the surface portion between the opening portion and the outer environment at the intimate contact surface portion of the acoustic hole when the intimate contact surface portion is mounted to the body of the user and placed in intimate contact with the surface of the body of the user.

3. A wearable electronic device including an enclosure having an electroacoustic device therein, said enclosure having an inner surface surrounding the electroacoustic device, and an outer surface that is placed in contact with the body of a user during mounting, the enclosure having an acoustic hole extending through a wall portion of the enclosure between said inner surface and said outer surface, said wearable electronic device being utilized while mounted to the user s body, wherein
said enclosure has acoustic signal propagation path formation means providing an acoustic signal propagation path permitting propagation of acoustic signals along a surface portion of the outer surface around an opening portion of the acoustic hole between the opening portion of the acoustic hole and the outside environment when the enclosure is mounted to the user's body and the surface portion around the opening portion touches the user's body.

4. The wearable electronic device of claim 2, wherein the acoustic signal surface propagation path formation means includes discretely formed plural convex portions on said surface portion of the outer surface of the enclosure.

5. The wearable electronic device of claim 4, wherein each of said convex portions is arc-shaped.

6. The wearable electronic device of claim 4, wherein each of said convex portions is dome-shaped.

7. The wearable electronic device of claim 2, wherein the acoustic signal surface propagation path formation means has groove portions formed in said surface portion.

8. The wearable electronic device of claim 1,
wherein the enclosure is made up of an enclosure body portion and a cover portion,
wherein the enclosure body portion has a body inner surface surrounding the electroacoustic device to define the inner surface of the enclosure, the enclosure body portion having an acoustic hole extending through a wall portion of the enclosure body portion between the body inner surface and a body outer surface on the opposite side of said body inner surface,
wherein the cover portion includes a cover outer surface and a cover intimate contact surface portion defining an outer surface of the enclosure and its intimate contact surface portion, respectively, the cover portion being mounted to the enclosure body portion so as to cover a region of the body outer surface containing an opening portion of the acoustic hole, and
wherein the acoustic signal propagation path formation means has an acoustic signal inner propagation path between the body outer surface and a portion of the cover portion that is opposite to the body outer surface, the acoustic signal inner propagation path permitting propagation of acoustic signals between an exposed surface portion and the opening portion of the acoustic hole in the body outer surface, the exposed surface portion moving off the surface of the user's body and facing the outer environment, when the cover intimate contact surface portion of the cover outer surface is so mounted as to make intimate contact with the surface of the user's body.

9. A wearable electronic device having an electroacoustic converter and an enclosure, said enclosure having an enclosure body portion, an acoustic hole, and a cover portion, said enclosure body portion having a body inner surface surrounding the electroacoustic converter, said acoustic hole extending through a wall portion of said enclosure body portion between said body inner surface and a body outer surface on the opposite side of said body inner surface, said cover portion having a cover outer surface including a cover intimate contact surface portion that is placed in intimate contact with the surface of the user's body when the device is mounted, said cover portion being mounted to the enclosure body portion so as to cover a region of the body outer surface that contains the opening portion of the acoustic hole, wherein
acoustic signal inner propagation path formation means provides an acoustic signal inner propagation path permitting propagation of acoustic signals between an exposed surface portion and the opening of the acoustic hole in the body outer surface, said acoustic signal inner propagation path formation means being formed between the body outer surface and a portion of the cover portion that faces the body outer surface, said exposed surface portion moving off the surface of the user's body and facing the outer environment, when the cover intimate contact surface portion of the cover outer surface is so mounted as to make intimate contact with the surface of the user's body.

10. The wearable electronic device of claim 8, wherein the acoustic signal inner propagation path formation means has convex portions formed on at least one of the body outer surface and the cover inner surface.

11. The wearable electronic device of claim 9, wherein the acoustic signal inner propagation path formation means has convex portions formed on at least one of the body outer surface and the cover inner surface.

12. The wearable electronic device of claim 8, wherein the acoustic signal inner propagation path formation means has groove portions formed in at least one of the body outer surface and the cover inner surface.

13. The wearable electronic device of claim 9, wherein the acoustic signal inner propagation path formation means has groove portions formed in at least one of the body outer surface and the cover inner surface.

14. The wearable electronic device of claim 1, wherein the electroacoustic converter is a microphone or a speaker.

15. The wearable electronic device of claim 1, incorporating cell phone functions.

16. The wearable electronic device of claim 1, wherein the wearable electronic device is of an arm-mounted type whose enclosure is mounted to an arm.

17. The wearable electronic device of claim 1, wherein the enclosure is made movable between a first position where the enclosure is mounted to an arm and a second position where the enclosure is detached from the arm, and wherein there is provided another opening permitting access to the electroacoustic converter in the second position.
